(19) United States
(12) Patent Application Publication
(10) Pub. No.: US 2008/0231549 A1
(43) Pub. Date: Sep. 25, 2008

(54) Display And Control Device Therefor

(76) Inventor: Brieuc Rolland Du Roscoat, Maisons Lafittte (FR)

Correspondence Address: OLIFF & BERRIDGE, PLC, P.O. BOX 320850, ALEXANDRIA, VA, 22320-4850, US

(21) Appl. No.: 11/792,050

(22) PCT Filed: Oct. 28, 2005
(86) PCT No.: PCT/FR2005/002707

§ 371 Date: Jun. 25, 2007

(30) Foreign Application Priority Data
Oct. 28, 2004 (FR) 0411501

(51) Int. Cl. G09G 3/04

(52) U.S. Cl. 345/33

(57) ABSTRACT

The display (10) comprising a number of basic display elements arranged according to a plotting representing an alphanumeric character, and it is linked to transcoding circuits (2, 3) that, after receiving data representing a digit, furnish a specific set of individual commands for various basic display elements, whereby this furnished set excites a certain number of basic elements according to a pattern specific to the digit.

The present invention relates to a display for displaying a digit and a device to control such a display.

Conventionally, to display the value of a digit, there are two types of displays, i.e. the seven-segment displays, in the shape of two superimposed squares with a common side, with also possibly slanted segments, and the displays as a thirty five dots matrix, with seven rows of five dots, whose fine granularity allows to define enhanced curves and thus to also display letters.

The present invention aims at providing another type of display.

To this end, the invention relates at first to a display for a value in a range of a first plurality of possible values of a digit, comprising a second plurality of display base elements independent one from the other to display any of said values by control of one of said first plurality of base elements groups whose respective positions form together a pattern specific to the considered value, wherein said respective positions of all the second plurality are arranged in a base pattern whose shape substantially represents an alphanumeric character.

Thus, the display comprises a displaying background formed by the various base elements, i.e. dots or dots blocks, showing as a whole the predetermined shape of an alphanumeric character, this shape being defined by the fact that the various positions, even if they are disjoined one from the other, show some degree of dotted continuity suggesting a curve whose layout represents the considered alphanumeric character, which is thus unchanging. This layout thus corresponds to some correlation between the positions. But these positions also show other relative positions correlations because they allow to display successively the various values of the digit, i.e. in the second positions plurality, a sufficient number of different base elements groups may be defined, thus allowing to display, by specific patterns formed by some controlled base elements, the first plurality of the digit values.

It will be noted that, as the invention is not limited to a particular calculation base, a displayed value may correspond to a digit expressed in a determined base as well as a number, i.e. with at least two digits, expressed in a base lower than the other.

One of the base element positions may be located, in the base pattern, at a level specific to the considered base element.

The considered base element may, for example, indicate the odd values, to thus better distinguish the difference between two patterns of relatively close shapes.

This considered base element may, in particular, be at a level either extreme or halfway up in the base pattern and, besides, it may show a display state different relatively to the display states of the other base elements, for example a specific color, intensity, flashing or flashing frequency.

The base pattern may, in particular, substantially represent a letter among the group comprised by the letters d, E, I, L, O, V.

At least one of the base elements may, however, show an elongated shape and at least another of the base elements may show a substantially circular shape, i.e. with a length/width ratio not exceeding 2.

Preferably, the base pattern is bi-dimensional, in particular preferably for the digits exceeding “2”, which provides a wide diversity of specific bi-dimensional patterns and thus allows to better differentiate them.

The base pattern is, preferably, visible at rest.

The invention also relates to a display assembly comprising several displays according to the invention, in order to display a number.

The assembly may thus comprise at least two displays arranged so that each displays a value among respectively at least two values and at least eleven values.

A number of hours or minutes may thus be displayed, possibly by a time multiplexing between these two numbers, the zero digit being then indicated by display default, otherwise both displays are arranged so that each displays a value among respectively three values and twelve values.

The display assembly may comprise four displays of letters, as indicated above, whose base patterns represent respectively the letters L, O, V, E.

In such a case, to display the time or its subdivisions, the four displays advantageously comprise second pluralities of respectively 2, 9, 5 and 9 display base elements, for the hour and the minutes, with possibly a time multiplexing for the seconds and also for the date.

The invention further relates to a control device of a display according to the invention, wherein it comprises transcoding means arranged to, after having received data representing said digit, provide a specific corresponding set of individual controls for the various display base elements, the provided set belonging to a pool of a said first plurality of sets available for respectively the first plurality of the digit possible values.

The transcoding means may comprise a transcoding table in a read only memory, or else a binary counter comprising a third plurality of binary stages each having a serial input for the counting and an output connecting them serially, a first said stage being provided to receive, through the counting serial input, a continuous stream of pulses of determined period, the plurality of outputs further being connected to inputs of a transcoding combinatorial logic circuit having outputs to provide feedback controls arranged to control a said third plurality of storage priority control parallel inputs, in respectively the stages, of respective bits representing a transcoded number.

The counter, which would progress according to the conventional succession of growing binary values if it was autonomous, here progress by jumps. Effectively, being in a state corresponding to a N value providing directly the desired values for a current number to be displayed, generally binary, for the display base elements, the counter is incremented by one by mean of a counting pulse. The N+1 value appearing at the output then controls the combinatorial logic circuit, which, in response, overrides in parallel the counter stages to make it pass instantly to a N+k predetermined state that corresponds to a new set of controls, corresponding to the pattern of the next digit to be displayed. The new number stored in the counter may thus be chosen independently from the previous one, the k increment, which does not appear directly and is quoted here for the comprehension only, being positive or negative.

The transcoding means are advantageously arranged so that any two adjoining sets, in an ordered sequence of eight first said individual controls set, for respectively the values 1 to 8, each have at least two different controls relatively to the adjoining set.

In terms of information theory, the difference between two such coded information sets is called the Hamming distance, i.e. the minimal bits number that should change their state if it was wished to pass from a specific pattern to another. The specific patterns are thus all the better distinguishable one from the other that the Hamming distance is high.

In an embodiment, the transcoding means are arranged so that, in some of the control sets, the display controls of the respective values correspond to base elements positions arranged in said specific pattern substantially representing a conventional writing form of the considered value.

The digit, for example, may thus, if the base pattern allows it, be displayed by some number of display base elements whose relative positions suggest the shape of a 7. In addition or instead, it may be provided that the considered positions be seven in number.

To display a digit in decimal base, with a default zero value display, the transcoding means may be arranged to provide, selectively, one among a said first plurality of nine individual controls sets, for respectively values in a said range from 1 to 9, each controls set including a number of controls equal to the value to be displayed.

The transcoding means are advantageously arranged to control an array of display control circuits arranged to invert the feed polarity of a said second plurality of dipoles, forming the display base elements and each providing a choice of two possible colors according to the polarity, and further arranged to inhibit on command the dipoles.

The invention further relates to an assembly of control devices according to the invention, comprising an assembly of said transcoding means for respectively the displays of an assembly according to the invention.

So that two said digits of same value are represented by two patterns substantially alike of two of the displays, the transcoding means are advantageously arranged so that both respective sets of individual controls are in harmony one with the other in order that both said respective groups are formed by base elements being at positions defining two patterns of substantially the same shape.

First and second of said transcoding means may be coupled one to the other so that the first transcoding means control an increment of the second transcoding means when the first transcoding means reach a value representing a numbering base.

In this case, the first transcoding means may be arranged to provide, selectively, one among a said first plurality of at least nine individual controls sets, for respectively values in a said range from 1 to 9, each controls set comprising a controls number equal to the value to be displayed.

In the case of a mechanical display, a step motor may be provided, arranged to, by the control of the transcoding means, drive a movable display track on which are distributed said display base elements patterns, cooperating with a pattern pointer.

The invention relates finally to a display system comprising a display or a display assembly according to the invention, the system being characterized in that it comprises a control centre including control centre management means arranged to control, at the occurrence of events of predetermined type, display control means provided to control one said display comprising some said display base elements.

The events, for example, are current minute changes provided by a time base or any other event detected by a suitable sensor, for instance the arrival of image data to be displayed.

Effectively, according to an interesting embodiment, each display base element is comprised of a pixels block and the display control means are arranged to display an image specific to each pixels block.

The control centre management means are, for example, arranged to select an image in a library and to address it to a specific pixels block through the display control means.

The library is preferably designed to provide moving images data and the control centre management means are arranged to transmit, to the display control means, data packets including a sequence of said images.

If the moving image data are matched, in library, to service data specifying an image type among several possible types, the control centre management means may be arranged to virtually divide the display in several areas and, for each area, to select images of a type specific to the considered area.

To animate the display, or to better show an image, the control centre management means may be arranged to periodically compute expanded image data representing an image in a format suited to be displayed on several said pixels blocks and to transmit expanded image data to the considered pixels blocks.

The library is advantageously connected to a data transmission network, as input and/or output, in order to receive various images from terminals like, for example, mobile phones or else television channels, and to offer them for a display.

The display control means and the display, and possibly the control centre, may be provided integrated into a portable terminal, e.g. a mobile phone station or a watch, in which the desired images have been stored in the library, or else are received through a radio link.

The invention will become even more apparent from the following description of an embodiment of an assembly of such control devices and displays arranged according to the invention and of a data transmission system to manage such an assembly, and from the accompanying drawings in which:

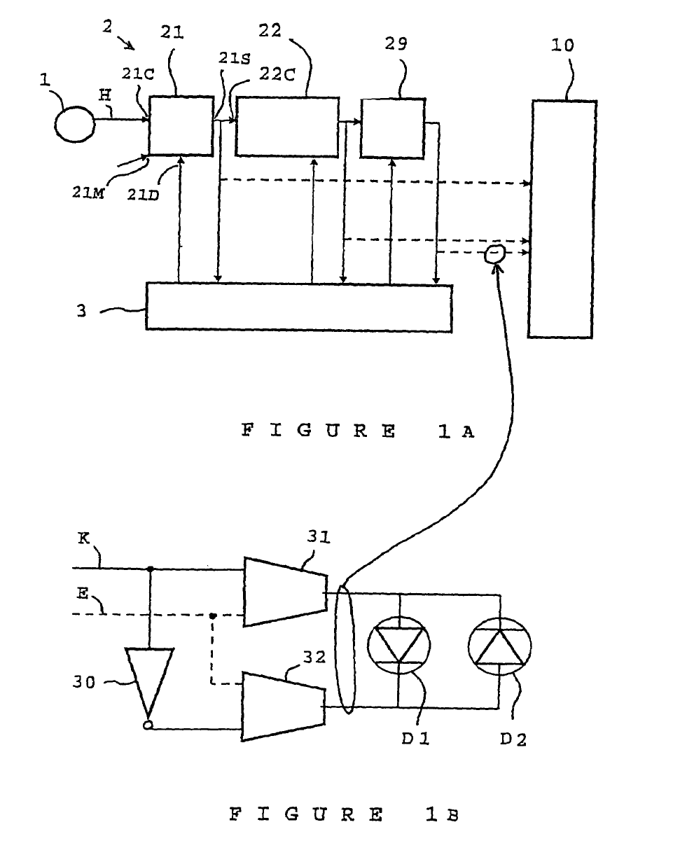

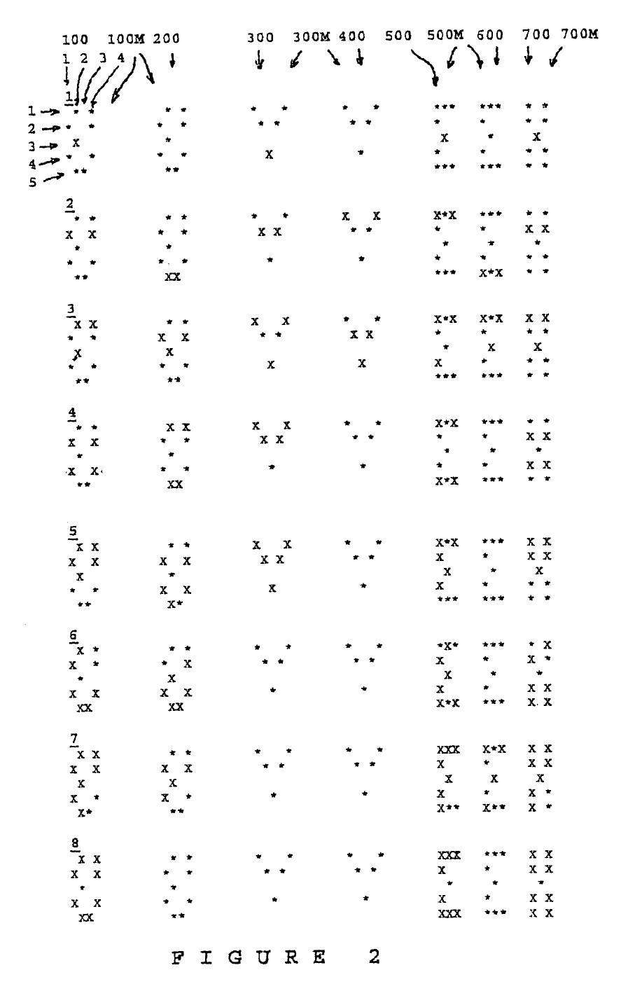

FIG. 1, formed by FIGS. 1A and 1B, is a functional block diagram showing an electronic watch display control assembly, FIG. 1B showing a detailed part of a display control circuit,

FIG. 2 shows a particular example of a watch three displays assembly and of an alternative embodiment of the last one, that allows to display, with a head display not shown, the hour and the minutes on a base pattern representing the English word LOVE,

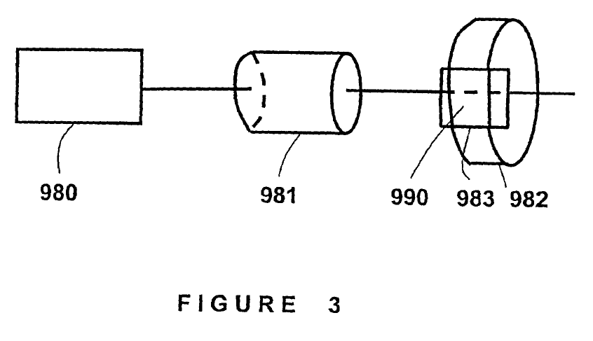

FIG. 3 shows a mechanical alternative embodiment of a display according to the invention,

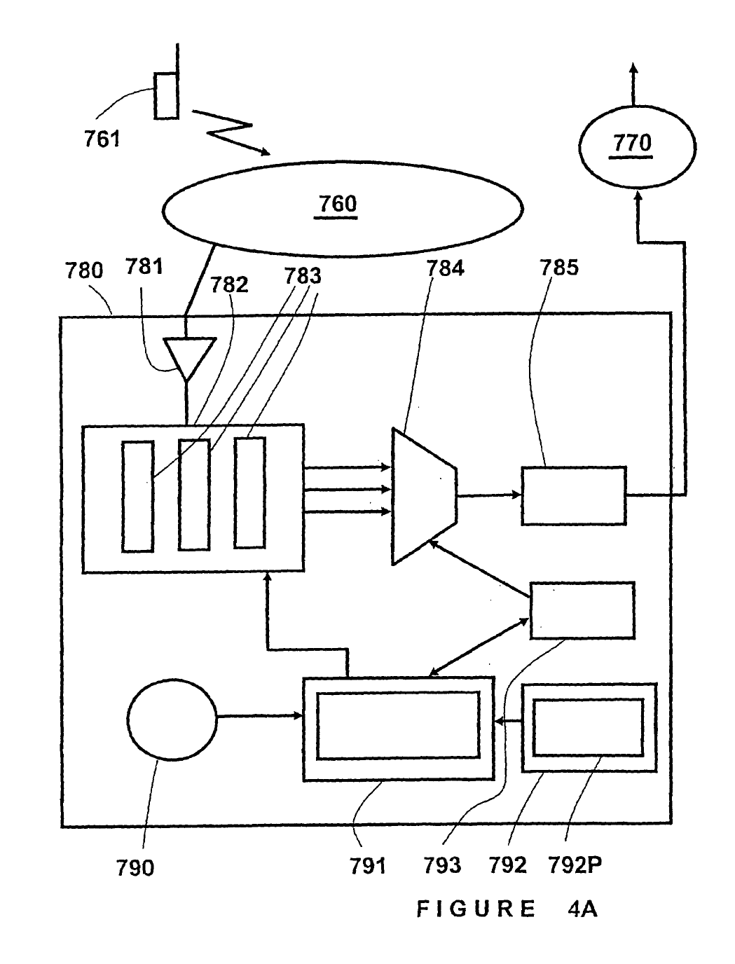

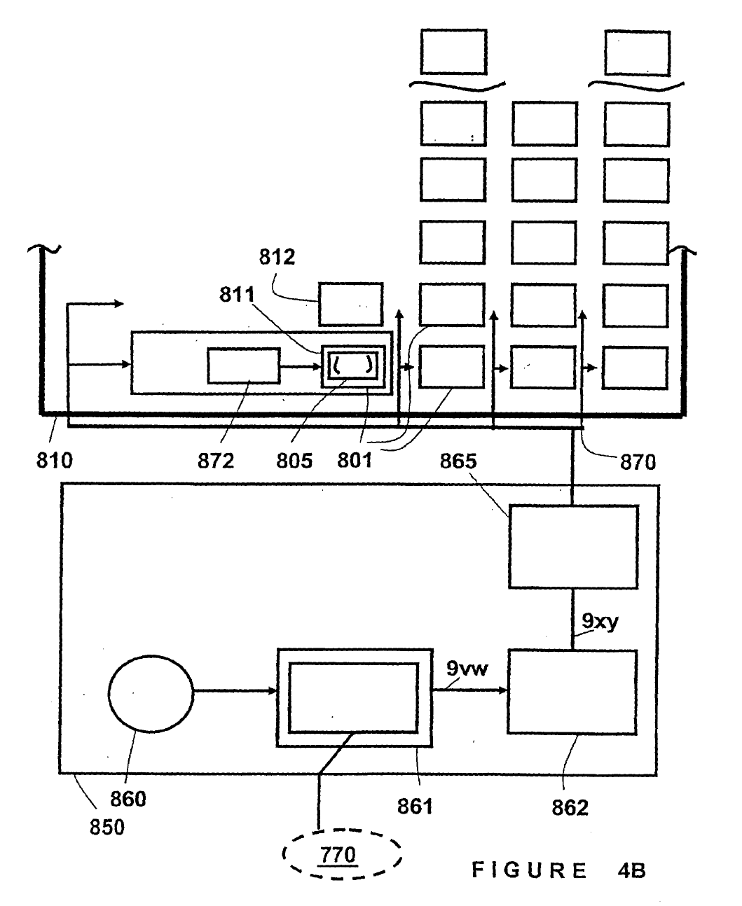

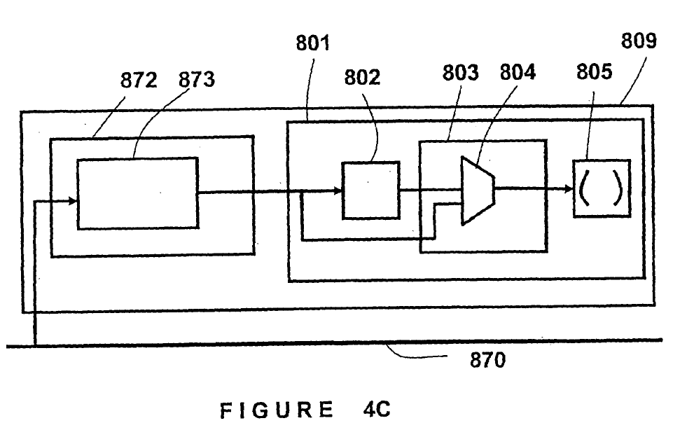

FIG. 4, formed by FIGS. 4A, 4B and 4C, is a functional block diagram showing a data transmission system including a display management system according to the invention, comprising a monitors tile, and

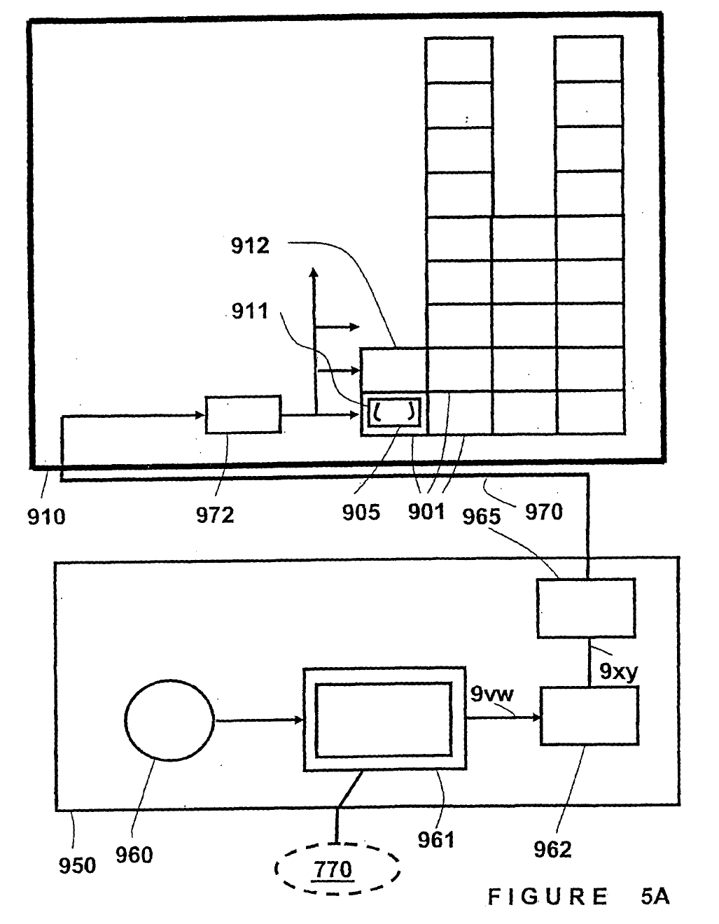

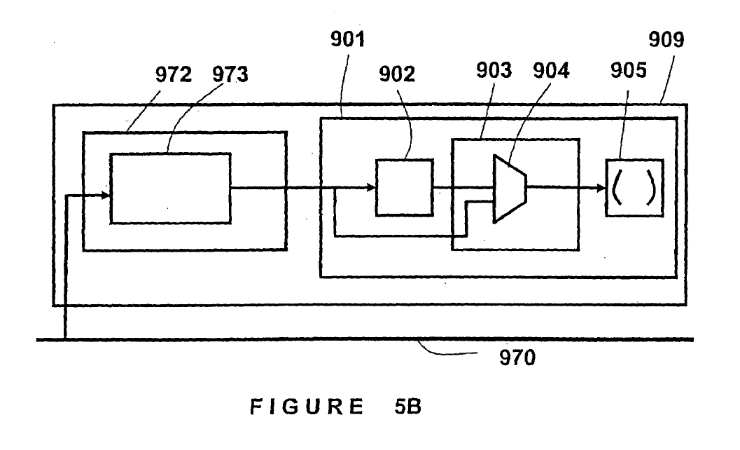

FIGS. 5A and 5B, forming FIG. 5, show respectively an alternative embodiment of the FIGS. 4A and 4B system, for a display in a mobile phone station.

FIG. 1 shows an oscillator 1 controlling a transcoding assembly comprised of a binary counter 2 connected to a combinatorial logic circuit 3 itself controlling a display 10.

The counter 2 comprises a plurality of a series of here nine identical binary stages connected in a string, not all shown, a most upstream stage bearing reference 21 and a most downstream stage bearing reference 29. The first stage 21 comprises a counting serial or upstream input 21C and a corresponding downstream output 21S and, additionally, a side input 21D to receive a binary data to be stored by the control of a clock signal applied at a storage control input 21M. The side input 21D have precedence over the counting input 21C, i.e. the occurrence of an active edge transition on the storage control input 21M initiates the storage of the bit of the side input 21D. The bit previously contained in stage 21, coming from a counting of the upstream serial pulses or else from a previous storage by side access, is thus erased if it was different form the new stored bit.

The counting input 21C of the first stage 21 receives a continuous stream of pulses H of determined period, coming from the oscillator 1 and thus changes its state at each active edge of the clock signal H, i.e. it operates conventionally as a frequency divider by two, the output 21S controlling a counting input 21C of a following stage 22. The following stages in a string each execute in the same way a frequency division by two. The plurality of the nine corresponding outputs, like the output 21S, each control, in the display 10, a display base element specific to each of them.

The plurality of above outputs, that will be generally indicated by the reference (21) of the first one, besides, is further connected to inputs of the combinatorial logic circuit 3, which realizes a transcoding from a binary value represented by the respective nine bits of the outputs (21) of the counter 2, into another predetermined binary value. The combinatorial logic circuit 3 may be comprised of a FPLA type circuit (for “Field Programmable Logic Array”) or similar, including a number of logic gates AND, OR, exclusive-OR, memories and if necessary counters. These circuits may be connected through an array set in one or several rows and columns matrix initially isolated from one another, i.e. whose crossing points are initially opened but comprise a read only memory point formed by a local fuse or a micro-capacitor controlling a micro-switch. Storage controls addressed to the desired crossing points then allow to set all the desired path in order to connect as wished the various logic circuits, that may thus realize a desired function, i.e. here a transcoding. Alternatively, a transcoding table may be provided in a conventional read only memory containing the desired transcoding values.

The combinatorial logic circuit 3 comprises nine outputs that are connected to the respective storage inputs of the various stages, like the storage input 21M. This thus realizes a feedback looping that replaces, in the counter 2, the current binary value by the corresponding transcoded value. The storage of the transcoded value is controlled in parallel at the storage input 21M and at the other eight homologous inputs by a clock active edge phase shifted relatively to the edge of the clock signal H. Here, practically, the counting input 21C is designed for upward active edges and the storage input 21M for downward active edges. Thus, the clock signal H is applied to the counting input 21C of the first stage 21 and also to the nine storage inputs 21M and homologous. The display 10 being here directly controlled by the plurality of outputs (21), the clock signal H exhibits a form factor relatively low, such that its second active edge, going downward for the storage, closely follows the first active edge, going upward for the counting progression, in order that the display 10 do not show a visible transient state.

As will be described below with reference to FIG. 1B, in this example each display base element is a dipole comprised of two LED diodes D1, D2 of different colors commonly encapsulated and connected head to foot to each other with possibly a common current limiting serial resistor, i.e. the feeding current direction determines which LED will be illuminated. Each control connection of such a LED coming, in this case, directly from the combinatorial logic circuit 3, thus comprises two conductors, i.e. a conventional conductor of binary inhibition/activation control E of the LED and a control transmission conductor K for the color choice, acting as switching control to selectively invert the current direction. The activation S signal E is in parallel applied to two respective inputs of two identical logic gates with two inputs, i.e. OR logic gates as shown, possibly inverting or, alternatively, AND logic gates, possibly inverting. In the present case, an activation signal E at 1 (alternatively 0) goes in priority to the outputs of both gates 31, 32, independently of the other input state. The two other inputs of both gates 31, 32 receive respectively the color selection signal K and this same signal inverted by an inverting logic gate 30. The signal E being at 0 to unlock, a signal K at 0 brings a 0 at the output of gate 31 and a 1 at the output of gate 32, which thus feeds the LED diodes dipole and makes conductive, according to the drawing, LED D2, or else a state 1 of signal K inverts the direction of the dipole bias and then makes conductive the diode D1. The gates 30 to 32 may be integrated in the combinatorial logic circuit 3, which is thus, as indicated above, designed to control directly the display 10, without going through counter 2, as an alternative of FIG. 1.

A connection in string of two such first and second transcoding assemblies may be provided, connected to each other in order that the first transcoding assembly controls an incrementing of the second transcoding assembly when the first transcoding assembly reaches a value representing a numbering base. In such case, for example for a display in decimal base, when the counter 2 of the first assembly is in the state corresponding to a display of the unit “9”, the receiving of a clock pulse H makes the counter 2 progress as described above and the new corresponding state is decoded to provide a carry signal which is equivalent to a clock pulse H for the counter 2 of the second assembly, located downstream. The combinatorial logic circuit 3 may be used as a decoder of the value corresponding to the base minus one unit, here “9”, to make the downstream counter 2 progress when the upstream counter 2 leaves the state “9”, thus indicating that a clock pulse H has just been received.

The first transcoding assembly may thus be arranged to provide, selectively, one among a first plurality of at least nine, possibly ten, individual controls sets, for respectively values in a said range from 1 to 9, possibly from 0 to 9. Each controls set may comprise, for example, a number of controls equal to the value to be displayed.

FIG. 2 is an array of eight superimposed horizontal blocks, each formed of five rows numbered in margin from 1 to 5 for the first block, each block representing four such displays 100, 300, 500, 700, but each of a particular type, i.e. each having a particular base pattern, suggesting respectively the letters O, V, E and once more E, the fourth display 700 being an alternative of the third display 500. The above displays are in fact represented here by the base pattern 100M, 300M, 500M, and 700M they show. The above four displays allow to display respectively digits from 1 to respectively 9, 5, 9, 9, i.e. hour units, minutes tens and minutes units. The eight blocks of rows show respectively the representations of the digits from 1 to 8.

In each block, the displays 100, 300, 500 are possibly shown a second time, thus with the same base pattern, with the respective references 200, 400, 600 to show an alternative of the illuminated LED pattern, specific to the considered digit. The reference 700 indicates an alternative of the third display 500, 600, relatively to the LED relative positions.

Asterisks * indicate the various positions of the display base elements at rest and crosses X indicate positions of activated display base elements, the whole forming the base pattern.

In this example are used light-emitting diodes, or LED, that could be replaced by display zones of liquid crystals, LCD. For this latter case, it will be recalled that the aspect difference of the zones is obtained by a change of the optical transmission coefficient, i.e. it may be said that the zones are activated but not that they are illuminated, the light source needed being external and provided in the vicinity. It shall be noted that it may also be provided that the corresponding LED positions are represented on a conventional computer screen or any other display panel, possibly also suitable to displays of a type outside the scope of the present invention.

In the following description, for the sake of explanation convenience, the various LED are identified by a reference comprising a hundreds digit corresponding to that of the “basic” display 100, 300 or 500 for the considered type, a tens digit corresponding to the rank of row 1 to 5, starting from the top of the block as shown on the pattern 100M for the digit 1, of the row on which the LED is located, and a units digit, from 1 to 3 or 4 or 5, indicating the LED position in the row, starting from the left of the considered base pattern, as shown. These references stay the same in the eight blocks of rows shown. It shall however be noted that it may be provided to increase the width and/or the length of the base pattern by inserting respectively empty columns or rows, in which case the positions references of some LED would then have to be incremented in a corresponding fashion, relatively to respectively the unit and/or the ten.

The LED positions of the display 100, 200 comprise a central dot in the general representation of the letter O. Going downward row by row, there is thus a series of 2, 2, 1, 2, 2 LED at reference positions 112, 114 (or alternatively 113), 121, 124, 132, 141, 144, 152, 153.

The LED positions of the display 300, 400 generally representing the letter V show, going downward row by row, a series of 2, 2, 0, 1, 0 LED at reference positions 311, 315, 322, 324, 343 (alternatively 333). As an alternative, a V of maximum size may be defined by reference positions 311, 315, 332, 334, 353.

The LED positions of the display 500, 600 generally representing the letter E show, going downward row by row, a series of 3, 1, 1, 1, 3 LED at reference positions 511, 512, 513, 521, 532, 541, 551, 552, 553. The LED positions of the display 700 generally representing the letter E show, going downward row by row, a series of 2, 2, 1, 2, 2 LED at reference positions 711, 713, 721, 723, 732, 741, 743, 751, 753. The display 700 is thus differentiated from the display 500, 600 by the fact that the LED 512 and 552 of the middle of the two horizontal bars, respectively high and low of the E, are replaced by the LED 723 and 743 that form a shape of hook closing the free ends of those horizontal bars. The display 700 thus show a superimposition of two rectangles, formed by respectively the LED of the two first and the two last rows, separated the halfway up LED 732 and at a central column position, i.e. of tens 2. Such a shape is relatively the same as that of display 100, 200, which shows a base pattern comprising, at the top, a right-angled trapezium, or alternatively simplified (113), and, at the bottom, a same trapezium symmetrical but turned over, separated by the mid-level LED 132 located at an almost central column position.

The reference positions 132, 532, 732 are located halfway up the respective base patterns, while the reference position 343 is located at the low end of the V forming the base pattern, with an alignment possibility in a row with the above reference positions (alternative 333) or else a possibility to go down to low end position 353. Each of the above reference positions is the only one in the considered row in the considered base pattern and it may be indicated by a LED of a color different from the others of the base pattern, for example a red LED among green or orange colored LED, or by a specific illumination control LED, for example at an intensity more or less strong continuously or else flashing at a particular frequency.

As indicated above, here is provided that the LED is of bicolored type, i.e. each comprised of two diodes of different colors connected head to foot to each other to selectively turn on one of the two colors. It may thus, for example, be initially chosen to use LED of two colors among the red, green or orange group.

In this way, it may, for example, be chosen to display the even digits with some color, for example green, and the odd digits with another color, for example red.

To display the digit “1” on each of the four displays, the respective LED 132, 343, 532, 732 are turned on. Of course, each display is controlled independently from the other three and it may thus display any digit relatively to the digits of the others. The present display of the same digit on each of the four displays is for the sake of description convenience only.

The digit “0” being able to be indicated by the putting to rest of all the display base elements, its representation on FIG. 2 is thus unnecessary. The digit “0” might however be displayed by a reference position located on a row distant from that displaying the digit “1”, or else by a color change or an alternative such as a flashing, then possibly keeping the reference position of digit “1” or else at a lower position, in the row of rank 5.

To display the digit “2”, two LED of the same row are turned on, which gives four possibilities for the display 100, 200, here with, for example in row 2, the LED 121, 124 or 112, 114 or further 141, 144 or else, as an alternative (200) shown, 152 and 153. In the display 300, 400, the LED 321 and 323 shown, or else 311 and 315 of the alternative, are turned on. In the display 500, 600, any two LED of a horizontal bar are turned on, like, for example here, at reference position 551, 553. The display 700 gives four possibilities, for example 751, 753.

To display the digit “3”, three LED are turned on in each display to substantially form a V, respectively the pair 112, 114 (or 121, 124 of the alternative) with 132 (or 152 or 153), like the pair 311, 314 (or 322, 324 of the alternative) with 343 (or 333 or 353, not shown), like the pair 511, 513 with 541 (or 532 of the alternative or 551 or 552), like the pair 711, 713 (or 721, 723) with 732. It may thus happen that the diodes 132, 343, 541 and 732, which are each at a specific level in the considered base pattern, are turned on, i.e. each one is unique in its row in its base pattern.

To display the digit “4”, four LED are turned on in each display to form a rectangle or a symmetrical trapezium, respectively two of the pairs 121, 124, or 112, 114 or 141, 144 or 152, 153, like the pairs 311, 314 and 322, 324, like the pairs 511, 513 and 551, 553, like two of the pairs 711, 713 or 721, 723 or 741, 743 or 751, 753.

To display the digit “5”, five LED are turned on in each display to form a V, respectively the pair 121, 124 (or 112, 114) with 152 (or 153 or 131), like the pair 322, 324 (322, 324) with 343 (or 333 or 353), like the pair 511, 513 with 541 (or 532), like the pair 721, 723 (or 711 and 713) with 732.

To display the digit “6”, six LED are turned on in each display 100, 500, 700 in a pattern suggesting the shape of the digit “6”, having respectively two LED forming a tail above four other LED in a trapezium or rectangle or close shape, suggesting a closed loop of the digit “6”. To this end are concerned the reference positions 112 and 121 (or 124 and 132) with 141, 144, 152, 153, and also 512, 521 with 532, 541, 551, 553, and also 713, 721 (or 723, 732) with 741, 743, 751, 753.

To display the digit “7”, seven LED are turned on in each display 100, 500, 700 in a pattern substantially suggesting the shape of the digit “7”. To this end are concerned the reference positions 112, 114, 121, 124, 132, 141, 152, and also 511, 512, 513, 521, 532, 541, 551, and also 711, 713, 721, 723, 732, 741, 751. Both drawn alternatives 121, 124, 132, 141, and also 511, 513, 532, 551 show a display of the same type, but by four LED only.

To display the digit “8”, eight LED are turned on in the displays 100, 500, 700, i.e. all of them except the one that is each time unique in row 3, i.e. the reference positions 132, 532, 732, whose complementing turning on allows for example to display the digit “9”, which has been estimated unnecessary to be shown on FIG. 2.

It shall be understood that the present example shows particular cases only, relatively to the base patterns as well as the various specific patterns choices for the respective digits. In particular, the equality presented, in most above examples, between the reference positions number and the number to be shown is based on a representation coding principle that is indeed interesting, because there is then a correlation between the specific pattern that a viewer must recognize and the number of activated base elements, but however not mandatory. In other words, the representation of each digit is here realized, on the one hand, in an un-coded form, by activating a LED number equal to the considered digit, thus without requiring an introduction for the user, and, on the other hand, in a position coding form, for which each specific pattern makes a general reading easier, i.e. instantaneous, without requiring to count the LED.

However, for other examples, the number of reference positions in each base pattern might be less than the number to represent since its representation is coded. Effectively, for the present decimal example, four display base elements might be enough for the coding, but the base pattern would only be able to represent a limited number of letters and further the various coding would hardly be visible, i.e. with a Hamming distance of 1.

As an example for a display of digits in base “12”, and not decimal anymore, the display 100 allows to display the digit “10” (ten units) by turning on the top right reference position 114 and by locally isolating such an illuminated state by keeping at the off state the two adjoining reference positions aside 112 and below 124, the other reference positions being at any state.

The digit “11” (eleven) may likewise be displayed by turning on the reference position at the top left corner 112, according to the same principle, the two adjoining reference positions 114 and 121 being kept off and the other reference positions being at any state. The corners of reference positions 152 and 153 could also be used for a coding according to this principle.

In the present case, looking the specific patterns of the displays 100 and 700 shows that the codes of the digit from “1” to “4” are totally disjoined, i.e. no illuminating LED position is common to two adjoining patterns. The codes for the digit “5” and the digit “6” have but 2 illuminating positions in common with the respective previous code for the digit “4” or the digit “5”. The code for the digit “7” has 4 positions in common with the code for the digit “6” and the code for the digit “8” has six positions in common with the code for the digit “7”. The first N−1 codes (N=0 to 5) of the display 300 are all disjoined, except for the code for the digit 4, that has 2 positions in common with the code for the digit “3”. The various specific patterns thus exhibit an excellent power of visual separation.

Furthermore, the above example relates to a decimal base counting, which must not be considered a limit for the invention, since extra specific patterns may be provided.

Likewise, the display base elements may be chosen of a somewhat elongated shape to better show the base pattern and/or some of the patterns specific to the digits. In particular, a base pattern may then be provided with only two elongated display base elements so that each forms a L leg. The horizontal leg is, for example, activated to display a digit “1” and the leg is activated to display a digit “2”, the horizontal leg being simultaneously activated or kept at rest in order to, in this latter case, provide a third specific pattern of simultaneous activation to display a digit “3”, or else to display the digits from “0” to “2”. Thus, with the above displays the word LOVE may be displayed or else, in decimal base in this example, the tens and units of the hour and minute.

The type of embodiment described above, with bi-dimensional base patterns, may be reduced to linear base patterns. For example, for each base pattern above described, the leftmost column may be taken as head reference of the five row segments that make the base pattern and, having increased the inter-row spacing, each row segment may be fold down between the reference position of the considered row and the position reference of the next row below. The reference column then comprising all the LED thus arranged may stay a line, to form the letter I, or be distorted in any desired curve. It shall be noted that the first column of the displays 500, 700, possibly with the second column, shows a possible coding for the letter I. As an example, the letters S or O may thus be formed, that brings back respectively linear and looped shapes. At least the first N−1 successive displays (N=5 or 9 in the examples) of the numbers series displayed on the base pattern with the desired curve thus do not follow an continuous ordered progression turning on an additional LED at each time, but they “jump” since the various specific patterns are predetermined in an almost independent to each other fashion. The various specific patterns may effectively be chosen in an almost random fashion, in the extent that they are all different. The particular case, described in detail, of the choice of a number of illuminated LED equal to the digit to be displayed, still leaves a sufficient degree of freedom for specific patterns so that they are very neatly disjoined, as indicated by the Hamming distances that are always at least equal to 2, and often much higher than 2.

To display, for example, a current time, an assembly of displays may be provided substantially of the kind described above, showing the sequence of letters O, d, i, l, E. The displays for the letters “O” and “E” have been described in detail. The display for the letter “O” is, for example, controlled to display the day of the week, by a digit from 0 to 6 or from 1 to 7. The display for the letter “E” may be controlled to display the seconds. As described, the nine LED concerned allow to display at least ten different values and, as a maximum, 512 different values. For example, at the input of the display 700 may be provided a switch oscillating at a predetermined rate to be connected in turn to the first combinatorial logic circuit 3 or the second combinatorial logic circuit 3 for the seconds tens, downstream of the first one. The display of the seconds tens and units may be realized alternately, with at each time a specific color for each of the two displays or else a specific display duration.

The patterns of the intermediates letters “d”, “i”, “l” allow to display four values, i.e. the hours tens and units by the letter “d” and the minutes tens and units by respectively the letters “i” and “l”. The letter “i” substantially corresponds to the E vertical bar of the display 700, The intermediate level LED then being aligned in the left column. The letter “l” corresponds to an extrapolation of the above “i” up to nine or ten aligned LED. The letter “d” is formed by a display vertical bar up to 9, like the letter “l”, complemented at the left by two or three LED substantially vertically aligned to suggest the “d” loop, allowing the display up to 2.

FIG. 3 diagrammatically shows an alternative mechanism for an electromechanical watch. A step motor 981 drives, under the control of transcoding circuits 980, of the circuits 2, 3 type, a movable display track 982 on which are distributed some of said display base elements patterns 990, cooperating with a pattern pointer 983. The display track 982 is here a rotating disc or wheel comprising at the periphery, external or at the brim of a principal side, a circular track bearing a string of various display base elements patterns 990, cooperating with a display window 983 provided in a watch case, not shown. Four such mechanisms are provided to display the hours and the minutes. Alternatively, the above track is flat and supported by a alternating movable rack, in engagement with a gear controlled by the motor 981, the rack thus sliding to show the desired pattern at the place corresponding to the pointer, i.e. the display window 983 or an index. Alternatively, the index may move.

FIG. 4, formed by FIG. 4A, 4B and 4C, shows an example of a display management system according to the invention, which system, being more complex than the electronic assembly for the control of a watch display shown on FIG. 1A, allows in particular a dynamic management.

The system here comprises a data transmission network, here the Internet network, accessible in input to terminals or equipments 761 for a transmission of data representing fixed or animated images, for example computers terminals, television channels transmission stations or television receivers cooperating with a retransmission device or else mobile phones, as suggested by the drawing.

A control centre 780 is connected in input to the Internet network 760 to receive the images and distribute them into a display 810, here through a data transmission network 770, here local, and a local unit 850 locally managing the display 810, i.e. translating, at the physical level, logic commands coming from the control centre 780.

The display 810 is, in fact, here comprised of a television monitors tile, each referenced in a general fashion 801, provided in four successive stacks of 2, 9, 5 and 9 stages, in order to respectively show, by their display state, the hours tens, the hours units, the minutes tens and the minutes units. For the sake of the present description convenience, the monitors 801 may also be individually marked off by the hundred “8”, associated with a ten from “1” to “4” for their column, numbered in the above explanation order of decreasing weight values and with a unit ranging from “1” to respectively “2”, “9”, “5” and “9”, starting from the bottom of the considered stack.

Each monitor 801 corresponds, in its activation management point of view, to a pixel, or LED, of the previous example, but the monitor 801 displays, at the “activated” state, an image and not a simple dot or pixel anymore like a LED. Thus, apart from the desired binary information, visible by the fact that it is “turned on”, the monitor 801 allows to transmit additional information, like photos, a movie or else some evolutionary text. The “turned off” state, opposed to the “turned on” state, may correspond to a lack of image display or else to the display of an image having a predetermined characteristic allowing the observers to classify it as representing a “turned off” state, i.e. not to be taken into account for the digits counting. It may, for example, be an image representing a predetermined object, i.e. recognizable by outlines or else an image of predetermined color, whatever the represented object is.

The system is described in detail below.

The control centre 780 is connected as input to the Internet network 760 through a receiver circuit 781 receiving the transmitted images and transmitting them to a library memory 782. It shall be noted that the Internet network 760 as input and the terminals 761 are only optional, since the library 782 may be provided to be loaded from portable computer media, like for example cartridges, floppy disks, CD ROM or the like, or by a wiry or radio link from a terminal possibly local. The Internet network 760 is, in fact, provided here to open the system to public terminals 761.

The control centre 780 comprises a central unit 791, driven by a time base 790, managing the library 782 under the control of a program memory 792, with a manager program 792P. The manager program 792P realizes the proper feeding with images of each monitor 801, i.e. select, in the library 782, an image and control its transfer to a determined target monitor 801. The updating of each monitor 801 by a new image is realized according to a predetermined or varying period, while its activation/blanking is called into question each minute, by signals from the time base 790, that constitute “initiating” events. In the time base 790 or the central unit 791, clock circuits according to FIG. 1A or subprograms of the same function, provide the desired controls to display the desired number of hours and minutes, i.e. activate the desired number of monitors 801.

In the case of animated images transmission, it is a sequencer 793, in the form of a subprogram or a specific hardware sequencer, that provides, as a real time periodical background task, the transmission of each new image of the images sequence. The sequencer 793 has previously received, from the central unit 791 controlled by the manager program 792P, addresses specifying, for example by a beginning address and an ending address, a zone 783 of addresses in library 782, in which the sequence of data of animated images to be displayed may be found. The sequencer 793 has likewise received a network address of which display 801 it feeds, i.e. a network address of the local unit 850, complemented by a local address in the display 810, provided by a correspondence table starting from the aimed at position (row and column) in the display 810.

The sequencer 793 may thus, under the control of the time base 790, read in a cyclic fashion, for example according to a refreshing rate of 50 Hertz, successive positions of the considered zone 783, each representing an image. In this way, starting from the zone 783 beginning address, the sequencer 793 increments, at each reading, a counter used as a reading pointer. If the animated sequence to be displayed exhibits a size bigger than the memory size available in the considered zone 783, only the image data of a sequence beginning section are at first successively written, by means of a writing pointer browsing the zone 783. The reading pointer, that will afterwards synchronize a reading by a scanning following the writing pointer, will thus allow an overwriting of the read image data, in a beginning range (increasing) of the zone 783, with new image data coming from the Internet network 760 and representing a next section. In other words, the zone 783 is operated in the fashion of a ring browsed by the writing pointer and by the reading pointer, with some amount of phase shifting after it. The connection of the library 782 to the data transmission network 770 is realized through a reading dispatching circuit 784, i.e. a multiplexer, controlled by the central unit 791 or directly by the sequencer 793, dispatching the read image data to a circuit 785 of interfacing with the data transmission network 770. Each image is here transmitted in a data packet further including the network address of the local unit 850 and a logical address 9vw specifying which of the displays 801 is the receiver. The control centre 780 may thus manage several local units 850, with cooperating displays 801, located at a distance from each other.

The image data thus transmitted are received by a central unit 861, with a time base 860, of the local unit 850, which, by means of a transcoding table 862, transforms the logical address 9vw into a physical address 9xy of the aimed at monitor 801.

In this example, the various monitors 801 are connected to the local unit 850, precisely to network interface circuits 865 of the local unit 850, through a local network 870, here of the Ethernet type. The network interface circuits 865 thus transmit the image data in a message in the Ethernet format, with, in particular, the physical address 9xy of the receiving monitor 801. Each monitor 801 is connected to the local network 870 through a network interface circuit 872 providing the level 1 and 2 functions of the OSI classification, i.e. providing the desired interface physical level and suitable to process the data format.

Each monitor 801 and the cooperating network interface circuit 872 constitutes a monitor unit 909 and the assembly of the monitors units 909 with the local network 870 constitutes the display 810.

By comparison with the locally stored physical address of the considered monitor 801, the interface circuit 872, used as a front device, determines whether the message, stored in a buffer memory 873, has to be received by the downstream cooperating monitor 801. If such is not the case, the message is erased or will be overwritten by a next one and, if such is the case, the image data are fetched from it and transmitted to the cooperating monitor 801, with if needed a shaping suited to the display. The monitor 801 here comprises, at first, a buffer memory 802 to store the image data, which buffer memory 802 thus being able to be afterwards read, in a cyclic fashion, by a local sequencer 803 for the refreshing of the image, fixed or animated, with for example a refreshing at 100 Hertz of a screen 805 of the monitor 801.

Some correlation between the contents of the various displayed images may be provided, i.e. in the extent that the image data in library 782 will have been stored together with service data, such as a code word specifying an image subject type among several possible types, the manager program 792P may be designed to regroup a same type of displayed images in a same area of the display 810, for example a same column or a same stage level. In such a case, at the time of the selection in library 782, among the eligible images for the display, the manager program 792P selects an image type specific to each column and, for each monitor 801 of the considered column, it limits its search to the images of the type represented by the considered code word. The selected type may afterwards be replaced by another after some duration.

An adaptation of the image definition between the electronic image in library 782 and the image format of the monitors 801 may be needed. For example, a mobile phone may provide images of approximately 4 M pixels, while a monitor 801 comprises only, for example, 0.3 M pixels, i.e. approximately 16 times less. The sequencer 793 then executes a pixels mean values computation by blocks of 4×4, to define at each time a pixel value to be transmitted to the monitor 801. However, a sampling may simply be provided, with a pitch of value 4, in pixels rows and columns.

To realize in a cyclic fashion a magnifying effect is also provided, i.e. a displayed image will be expanded in area by a factor N and will overlap the images displayed on the adjoining monitors 801. To this end, the manager program 792P rereads the data of the considered image in library 782 and fragments the image in, for example, a tile of 4×4 images, each fragment being intended to be displayed on a whole monitor 801. Accordingly, the elementary image data, supposed to each represent a physical pixel of monitor 801, are duplicated to appear in a block having here N=16 times the area of a pixel. If needed, if the image data are in a compressed form, i.e. if generally the coding type operates some correlation level between adjoining pixels, to decode the image is then suited to fragment it and process the fragments, in order to afterwards individually recode them.

The manager program 792P may provide a smoothing processing between such pixels blocks, to limit the quantification effect, should the observers be too close to the monitors 801.

The N=16 images thus created are then transmitted to the considered monitors 801. They, for example, may be the monitors 801 located at the four lower stages of the four columns, with the addition of two additional monitors in the first monitors column 811 and 812, of hours tens, if somewhat truncating the expanded image is not wished.

The old displayed images, “overwritten”, may be retransmitted from the control centre 780 after some timing, to come back to the original state. It may also be provided that the expanded images be joined to service data indicating their kind and preventing the overwriting of the buffer memory 902 of monitors 801 by the expanded image stored in the interface circuit 872. For the latter, another access to the monitor 801 will then be provided, bypassing the buffer memory 902 and leading to a two channel multiplexer 904 of the sequencer 903. After a timing has reached its end, the sequencer 903 will then come back to its reading of its buffer memory 902 by switching of the multiplexer 904.

In the particular example of image definition described above, it shall be noted that, if an image expanding is realized with a factor N=16, no specific processing of image definition adaptation has to be executed, since the image data in library 782 are provided with exactly the desired reserve of image definition sharpness. The only difference is then to omit the above operation of averaging or sampling computation.

It shall be noted that the functions of images data transmission may be provided in an application scope wider than that of displaying a value, i.e. independently of any constraint of displaying some number of display base elements. Such will then be a system of dynamic images display, able to activate all the time any desired number of display base elements, this number being possibly constant, i.e. representing the number of the display base elements.

FIGS. 5A and 5B are functional diagrams of an alternative embodiment of the local unit 850 with the display 810 of FIGS. 4B and 4C, the functionally homologous elements of those of these figures bearing the same reference, except for the fact that the hundred is “9”.

The plurality of monitors 801 constituting the display 810 is here replaced by a single display 910, comprising a screen 905, cooperating with, and even here integrated to a data processing terminal. The above terminal may, for example, be a portable PC or the like and preferably suitable to the transmission of data, of the Wi-Fi or another type, or else a phone station, wiry or, as in this example, a mobile phone station 900.

The above described essential functions of the display 810 are unchanged. However, due to the now restricted size of the display 910, the local network 870 is replaced by a simple point to point link 970 between an interface circuit 965 and the local unit 950 and by a single interface circuit 972, with a buffer memory 973, managing a blocks array of physical pixels of the screen 905 through a buffer memory 902 and a sequencer 903 with a multiplexer 904. Each pixels block of the screen may thus show an image specific to it, the screen pixels blocks for example 911, 912 corresponding to the monitors 811, 812. The pixels blocks size being however limited, the magnifying effect described above allows in a cyclic fashion to better see each image. It may in particular be provided that the user could, by a keyboard of the mobile, select himself an image to be momentarily expanded.

Such a mobile phone 900 may, alternatively, constitute itself the system according to FIG. 4, except of course the network 770, i.e. with the control centre 780, to, in particular, receive image data from a transmitter equipment like for example the terminal 761, i.e. possibly being a mobile phone. A radiotelephonic, cellular or satellite network of the mobile transmitter stations 761 may, in particular, be used instead of the Internet network for the transmission of the image data.

The mobile receiver station 900 then comprises a local unit 950 including a multitask telephonic central unit 961, with a time base 960 and a transcoding table 962, providing at the same time, in time sharing, the conventional functions of bi-directional transmission of the desired voice data, but also the operation of the image data, transmitted in a channel of computer data, i.e. the functions of the control centre 780 and of the local unit 850. In this way, apart from the OSI levels 1 to 3, allowing the exchange of service messages for the connection and the disconnection of the calls, the telephonic central unit 961 also provides the higher OSI levels and, in particular, the levels 6 and 7 relative to the present application of presenting image information.

Taking into account the fact that the telephonic function may be provided at the same time as the images display function, the latter is processed as a background task by the telephonic central unit 961, i.e. the image data received through a data transmission channel are momentarily stored, to be processed when the telephonic central unit 961 is available. The task of image data processing is thus related to a priority level lower than a priority level of the telephonic data processing.

Alternatively, the indicated circuits of the above mobile phone may belong to a watch, i.e. the phonic circuits are then omitted. The watch may however keep wiry or radio image data reception circuits.

1. Display for a value in a range of a first plurality of possible values of a digit, comprising a second plurality of display base elements independent one from the other to display any of said values by control of one of said first plurality of base elements groups whose respective positions form together a pattern specific to the considered value, wherein said respective positions of all the second plurality are arranged in a base pattern whose shape substantially represents an alphanumeric character.

2. Display according to claim 1, wherein one of the base element positions is located, in the base pattern, at a level specific to the considered base element.

3. Display according to claim 2, wherein said base element at a specific level is at a level either extreme or halfway up in the base pattern.

4. Display according to claim 2, wherein said base element of specific level is arranged to show a display state different relatively to the display states of the other base elements.

5. Display according to claim 1, wherein the base pattern substantially represents a letter.

6. Display according to claim 5, wherein the base pattern represents a letter among the group comprised by the letters d, E, I, L, O, V.

7. Display according to claim 1, wherein at least one of the base elements shows an elongated shape and at least another of the base elements shows a substantially circular shape.

8. Display according to claim 1, wherein the base pattern is bi-dimensional.

9. Display according to claim 8, wherein each specific pattern is bi-dimensional for the digits exceeding 2.

10. Display according to claim 1, wherein the base pattern is visible at rest.

11. Display assembly comprising several displays according to claim 1, in order to display a number.

12. Display assembly according to claim 11, comprising at least two displays arranged so that each displays a value among respectively at least two values and at least eleven values.

13. Display assembly according to claim 12, wherein both displays are arranged so that each displays a value among respectively three values and twelve values.

14. Display assembly according to claim 11, comprising four displays, whose base patterns represent respectively the letters L, O, V, E.

15. Display assembly according to claim 14, wherein the four displays show second pluralities of respectively two, nine, five and nine display base elements.

16. Control device of a display according to claim 1, wherein it comprises transcoding means arranged to, after having received data representing said digit, provide a specific corresponding set of individual controls for the various display base elements, the provided set belonging to a pool of a said first plurality of sets available for respectively the first plurality of the digit possible values.

17. Device according to claim 16, wherein the transcoding means comprise a transcoding table in a read only memory.

18. Device according to claim 16, wherein the transcoding means comprise a binary counter comprising a third plurality of binary stages each having a serial input for the counting and an output connecting them serially, a first said stage being provided to receive, through the counting serial input, a continuous stream of pulses of determined period, the plurality of outputs further being connected to inputs of a transcoding combinatorial logic circuit having outputs to provide feedback controls arranged to control a said third plurality of storage priority control parallel inputs, in respectively the stages, of respective bits representing a transcoded number.

19. Device according to claim 16, wherein the transcoding means are arranged so that any two adjoining sets, in an ordered sequence of eight first said individual controls set, for respectively the values 1 to 8, each have at least two different controls relatively to the adjoining set.

20. Device according to claim 16, wherein the transcoding means are arranged so that, in some of the control sets, the display controls of the respective values correspond to base elements positions arranged in said specific pattern substantially representing a conventional writing form of the considered value.

21. Device according to claim 16, wherein the transcoding means are arranged to provide, selectively, one among a said first plurality of nine individual controls sets, for respectively values in a said range from 1 to 9, each controls set including a number of controls equal to the value to be displayed.

22. Device according to claim 16, wherein the transcoding means are arranged to control an array of display control circuits arranged to invert the feed polarity of a said second plurality of dipoles, forming the display base elements and each providing a choice of two possible colors according to the polarity, and further arranged to inhibit on command the dipoles.

23. Assembly of control devices according to claim 16, comprising an assembly of said transcoding means for respectively the displays of an assembly comprising several displays in order to display a number.

24. Devices assembly according to claim 23, wherein, so that two said digits of same value are represented by two patterns substantially alike of two of the displays, the transcoding means are arranged so that both respective sets of individual controls are in harmony one with the other in order that both said respective groups are formed by base elements being at positions defining two patterns of substantially the same shape.

25. Devices assembly according to claim 23, wherein first and second of said transcoding means are coupled one to the other so that the first transcoding means control an increment of the second transcoding means when the first transcoding means reach a value representing a numbering base.

26. Devices assembly according to claim 25, wherein the first transcoding means are arranged to provide, selectively, one among a said first plurality of at least nine individual controls sets, for respectively values in a said range from 1 to 9, each controls set comprising a controls number equal to the value to be displayed.

27. Devices assembly according to claim 23, comprising a step motor arranged to, by the control of the transcoding means, drive a movable display track on which are distributed said display base elements patterns, cooperating with a pattern pointer.

28. Display system comprising a display according to claim 1, or a display assembly comprising several said displays in order to display a number, wherein said system comprises a control centre including control centre management means arranged to control, at the occurrence of events of predetermined type, display control means provided to control one said display (810, 910) comprising some said display base elements.

29. Display system according to claim 28, wherein each display base element is comprised of a pixels block and the display control means are arranged to display an image specific to each pixels block.

30. System according to claim 29, wherein the control centre management means are arranged to select an image in a library and to address it to a specific pixels block through the display control means.

31. System according to claim 30, wherein the library is designed to provide moving images data and the control centre management means are arranged to transmit, to the display control means, data packets including a sequence of said images.

32. System according to claim 31, wherein, the moving image data being matched, in library, to service data specifying an image type among several possible types, the control centre management means are arranged to virtually divide the display in several areas and, for each area, to select images of a type specific to the considered area.

33. System according to claim 31, wherein the control centre management means are arranged to periodically compute expanded image data representing an image in a format suited to be displayed on several said pixels blocks and to transmit expanded image data to the considered pixels blocks.

34. System according to claim 28, wherein the library is connected to a data transmission network.

35. System according to claim 28, wherein the display control means and the display are integrated into a portable terminal.

36. System according to claim 35, wherein the control center is integrated into the portable terminal.
